(19) United States
(12) Patent Application Publication
(10) Pub. No.: US 2021/0065232 A1
(43) Pub. Date: Mar. 4, 2021

(54) APPARATUS FOR DETECTING THE NUMBER OF PERSONS CONTACTED WITH ADVERTISING MEDIUM AND METHOD OF DETECTING THE NUMBER OF PERSONS CONTACTED WITH ADVERTISING MEDIUM

(71) Applicant: Kesion Co., Ltd., Tokyo (JP)

(72) Inventors: Makoto Nakayama, Tokyo (JP); Eri Ishikawa, Tokyo (JP); Sakura Jinno, Tokyo (JP)

(73) Assignee: Kesion Co., Ltd., Tokyo (JP)

(21) Appl. No.: 16/943,030

(22) Filed: Jul. 30, 2020

(30) Foreign Application Priority Data
Aug. 27, 2019 (JP) 2019-154228
Jul. 2, 2020 (JP) 2020-114569

(51) Int. Cl. G06Q 30/02; G01S 19/01

(52) U.S. Cl. CPC G06Q 30/0242; G01S 19/01

(57) ABSTRACT

An apparatus for detecting the number of persons contacted with an advertising medium, includes a visual-recognition range calculation unit for calculating a visual recognition ground range of the advertising medium based on a position of the advertising medium, a height above the ground of the advertising medium and a direction of an advertising surface of the advertising medium, a section extraction unit for extracting a plurality of sections in an area allowed persons to pass through, a section exclusion unit for excluding at least one section that is impossible to visually recognize the advertising medium from the plurality of sections extracted, an area specifying unit for specifying an area that contains the remaining sections except the at least one section excluded, and a contacted number calculation unit for calculating the number of persons contacted with the advertising medium by obtaining fluid population data of persons moving toward the advertising.

### BACKGROUND OF THE INVENTION

### Field of the Invention

The present invention relates to an apparatus for detecting the number of persons contacted with an advertising medium such as an OOH (Out of Home) medium or an outdoor advertising medium and to a method of detecting the number of persons contacted with an advertising medium.

### Description of the Related Art

It is said that the OOH mediums such as outdoor advertising mediums or traffic advertising mediums have more difficulty in measurement of the number of persons or people contacted with these advertising mediums than other typical advertising mediums. The number of persons or people contacted with the advertising mediums can be detected in general by sensing a viewing rate in the television mediums and the radio mediums, by sensing the number of issues in the journalism mediums, and by sensing the click-through count in the Internet advertising mediums. However, in the OOH mediums, since required is “compulsive visual recognition” or “passive visual recognition” but not “active visual recognition”, it is necessary to measure the number of passers in an open area in order to calculate the visual recognition number or the contacted people number. Thus, according to the conventional passenger number investigation, only viewing observation counting was executed. However, since such viewing observation counting took a great deal of labor, it was impossible to measure the contacted people number in all of the many OOH mediums.

Recently, since the location information service using the GPS (Global Positioning System) data of smartphones have been developed, the number of smartphones (the number of smartphone application users) existing around the mediums can be easily detected. It should be noted however that if the number of smartphone application users around the mediums is detected, this detected number is merely the number of smartphones but not the number of people existing around the mediums. Also, all the persons existing around the mediums do not necessarily perform viewing recognition of the mediums. Therefore, even if the number of people around the mediums is detected, it is impossible to correctly know the number of people contacted with the mediums.

In the Patent Document 1, disclosed is an advertisement response prediction system for predicting the number of the responses of media users to the advertisement. This advertisement response prediction system has a device for estimating the number of people who are interested in the advertisement without performing investigation of the number of people. However, the advertising medium disclosed in Patent Document 1 is an advertising medium in the newspaper but not the OOH medium. According to the advertising medium disclosed in Patent Document 1, therefore, the number of the advertisement attention people is calculated depending on the subscriber number of the newspaper as a rate for each publication configuration of advertisement.

### PATENT DOCUMENT

Patent Document 1: Japanese Patent No. 3673193

It should be noted that the advertisement response prediction system or the advertisement attention people number estimation system described in Patent Document 1 might be effective about the advertising medium of newspaper, but was not able to apply to the detection of the number of people contacted with the OOH medium at all.

### SUMMARY OF THE INVENTION

It is therefore an object of the present invention to provide an apparatus for detecting the number of persons contacted with advertising medium and a method of detecting the number of persons contacted with advertising medium, whereby, with respect to the OOH mediums, the number of the medium contacted persons can be precisely detected without really performing any people number investigation.

According to the present invention, an apparatus for detecting the number of persons contacted with an advertising medium, includes a visual-recognition range calculation unit for calculating a visual recognition ground range of the advertising medium based on a position of the advertising medium, a height above the ground of the advertising medium and a direction of an advertising surface of the advertising medium; a section extraction unit for extracting a plurality of sections in an area allowed persons to pass through, from a plurality of sections contained in the visual recognition ground range calculated by the visual-recognition range calculation unit; a section exclusion unit for excluding at least one section that is impossible to visually recognize the advertising medium from the plurality of sections extracted by the section extraction unit; an area specifying unit for specifying an area that contains the remaining sections except the at least one section excluded by the section exclusion unit; and a contacted number calculation unit for calculating the number of persons contacted with the advertising medium by obtaining fluid population data of persons moving toward the advertising medium in the area specified by the area specifying unit.

At first, a visual recognition ground range of the advertising medium is calculated based on a position of the advertising medium, a height above the ground of the advertising medium and a direction of an advertising surface of the advertising medium, and sections in an area allowed persons to pass through are extracted from sections contained in the visual recognition ground range. Then, a section or sections that are impossible to visually recognize the advertising medium are excluded from the extracted sections, and an area containing the remaining sections except the section or sections excluded is specified. The fluid population data of persons moving toward the advertising medium in the area specified is obtained and thus the number of persons contacted with the advertising medium is calculated. It should be noted that the fluid population data indicate estimated values of the population change based on the location information data provided by the data supplier, and that it is possible to obtain, from the data supplier, such estimated values of every area with a predetermined shape (for example, for one or more mesh units). The method of collecting such available fluid population data and the data format of the fluid population data are somewhat different depending on the data suppliers. Anyway, according to the present invention, since the visual recognition range of advertising medium is specified and the number of persons contacted with the advertising medium is obtained from the fluid population data moving toward the advertising medium within the specified range, the number of the medium contacted persons in an arbitrary time period can be always precisely and easily detected without really performing any people number investigation, even about the OOH mediums that are difficult for detecting the number of the medium contacted persons.

It is preferred that the area specifying unit includes a mesh specifying unit for specifying at least one mesh that contains the remaining sections except for the at least one section excluded by the section exclusion unit.

It is also preferred that the contacted number calculation unit includes a unit for obtaining fluid population data of pedestrians or persons on vehicles who are able to visually confirm the advertising medium.

It is further preferred that the contacted number calculation unit includes a unit for obtaining fluid population data of persons moving toward the advertising medium with a speed within a speed range corresponding a moving speed of pedestrians or a moving speed of vehicles.

It is still further preferred that the contacted number calculation unit includes a unit for obtaining fluid population data of persons moving toward a plurality of orientations that are defined based on a direction of the advertising surface of the advertising medium. The plurality of orientations may be 5 directions among 8 directions of the north, the northeast, the east, the southeast, the south, the southwest, the west, and the northwest.

It is further preferred that the mesh specifying unit includes a unit for specifying at least one mesh that contains a center of the remaining section except for the at least one section excluded by the section exclusion unit.

It is still further preferred that the visual-recognition range calculation unit includes a unit for calculating an arc range between a first arc having an arc center which is the center of the advertising surface and passing through a nearest visual recognition position, and a second arc having an arc center which is the center of the advertising surface and passing through a farthest visual recognition position, in case that an optimum visual recognition position is defined as a point of intersection with a first downward line and the ground, the first downward line being inclined by a first predetermined angle decided based on gaze stable visual field of humans from a perpendicular line of the advertising surface of the advertising medium, the perpendicular line passing through the center of the advertising surface, that the nearest visual recognition position is defined as a point of intersection with a second downward line and the ground, the second downward line being inclined by a second predetermined angle decided based on upward maximum visual field of humans from the perpendicular line of the advertising surface, and that the farthest visual recognition position is defined as a point away from the optimum visual recognition position on the ground by a distance between the optimum visual recognition position and the nearest visual recognition position in a direction opposite to the center of the advertising surface.

It is further preferred that the visual-recognition range calculation unit includes a unit for calculating the arc range within an angle range of 45 degrees in the right and left of the center of the advertising surface.

It is still further preferred that the first predetermined angle is 20 degrees and the second predetermined angle is 50 degrees.

It is further preferred that the section extraction unit includes a unit for extracting, in reference to a map data, sections in an area corresponding to roads within the plurality of sections contained in the visual recognition ground range.

It is further preferred that the section exclusion unit includes a unit for comparing a building height calculated with reference to a map data in each section through which at least one line connecting between the center of the extracted section and the center of the advertising surface passes, with a height of the at least one connecting line, and a unit for excluding the compared section from the plurality of sections extracted by the section extraction unit when the building height is higher than the height of the at least one connecting line.

It is further preferred that each of the sections extracted is a square-shaped grid.

According to the present invention, further, a method of detecting the number of persons contacted with an advertising medium, includes a step of calculating a visual recognition ground range of the advertising medium based on a position of the advertising medium, a height above the ground of the advertising medium and a direction of an advertising surface of the advertising medium; a step of extracting a plurality of sections in an area allowed persons to pass through, from a plurality of sections contained in the visual recognition ground range calculated; a step of specifying an area that contains the remaining sections except at least one section that is impossible to visually recognize the advertising medium and excluded from the plurality of sections extracted; and a step of calculating the number of persons contacted with the advertising medium by obtaining fluid population data of persons moving toward the advertising medium in the area specified by the area specifying unit.

At first, a visual recognition ground range of the advertising medium is calculated based on a position of the advertising medium, a height above the ground of the advertising medium and a direction of an advertising surface of the advertising medium, and sections in an area allowed persons to pass through are extracted from sections contained in the visual recognition ground range. Then, a section or sections that are impossible to visually recognize the advertising medium are excluded from the extracted sections, and an area containing the remaining sections except the section or sections excluded is specified. The fluid population data of persons moving toward the advertising medium in the area specified is obtained and thus the number of persons contacted with the advertising medium is calculated. It should be noted that the fluid population data indicate estimated values of the population change based on the location information data provided by the data supplier, and that it is possible to obtain, from the data supplier, such estimated values of every area with a predetermined shape (for example, for one or more mesh units). The method of collecting such available fluid population data and the data format of the fluid population data are somewhat different depending on the data suppliers. Anyway, according to the present invention, since the visual recognition range of advertising medium is specified and the number of persons contacted with the advertising medium is obtained from the fluid population data moving toward the advertising medium within the specified range, the number of the medium contacted persons in an arbitrary time period can be always precisely and easily detected without really performing any people number investigation, even about the OOH mediums that are difficult for detecting the number of the medium contacted persons.

It is preferred that the step of specifying an area includes a step of specifying at least one mesh that contains the remaining sections except for the at least one section that is impossible to visually recognize the advertising medium and excluded from the plurality of sections extracted.

It is also preferred that the step of calculating the contacted number includes a step of obtaining fluid population data of pedestrians or persons on vehicles who are able to visually confirm the advertising medium.

It is further preferred that the step of calculating the contacted number includes a step of obtaining fluid population data of persons moving toward the advertising medium with a speed within a speed range corresponding a moving speed of pedestrians or a moving speed of vehicles.

It is further preferred that the step of calculating the contacted number includes a step of obtaining fluid population data of persons in the specified at least one mesh, moving toward the advertising medium with a speed within a speed range.

It is still further preferred that the step of calculating the contacted number includes a step of obtaining fluid population data of persons moving toward a plurality of orientations that are defined based on a direction of the advertising surface of the advertising medium. The plurality of orientations may be 5 directions among 8 directions of the north, the northeast, the east, the southeast, the south, the southwest, the west, and the northwest.

### Effect of the Invention

According to the present invention, the number of the medium contacted persons in an arbitrary time period can be always precisely and easily detected without really performing any people number investigation, even about the OOH mediums that are difficult for detecting the number of the medium contacted persons. Further objects and advantages of the present invention will be apparent from the following description of the preferred embodiments of the invention as illustrated in the accompanying drawings.

### BRIEF DESCRIPTION OF THE DRAWINGS

FIG. 1 shows a block diagram schematically illustrating a whole configuration of an apparatus for detecting the number of persons contacted with advertising medium in an embodiment according to the present invention;

FIG. 2 shows a flowchart schematically illustrating an operation of detecting the number of persons contacted with the advertising medium in the embodiment of FIG. 1;

FIG. 3 shows views illustrating the objected advertising medium and the environment around the medium in the embodiment of FIG. 1;

FIG. 4 shows a view illustrating visible distances when the visual recognition range is calculated in the embodiment of FIG. 1;

FIG. 5 shows views illustrating visual fields of person applied in the embodiment of FIG. 1;

FIG. 6 shows a view illustrating visual recognition ranges calculated in the embodiment of FIG. 1;

FIG. 7 shows a view illustrating a state where square-shaped grids are superimposed on the visual recognition range in the embodiment of FIG. 1;

FIG. 8 shows a view illustrating a state where grids in an area allowed persons to pass through are extracted in the embodiment of FIG. 1;

FIG. 9 shows a view illustrating a state where a grid or grids that are impossible to visually recognize the advertising medium from the grids extracted are excluded in the embodiment of FIG. 1;

FIG. 10 shows views illustrating the state where a grid or grids that are impossible to visually recognize the advertising medium from the grids extracted are excluded in the embodiment of FIG. 1;

FIG. 11 shows a view illustrating an area after the a grid or grids that are impossible to visually recognize the advertising medium are excluded from the grids extracted in the embodiment of FIG. 1;

FIG. 12 shows a view illustrating an area with a smooth contour in comparison to the area of FIG. 11;

FIG. 13 shows a view illustrating a mesh containing the remaining grids after the a grid or grids that are impossible to visually recognize the advertising medium are excluded in the embodiment of FIG. 1;

FIG. 14 shows a view illustrating selected moving directions of each mesh in the embodiment of FIG. 1; and

FIG. 15 shows views illustrating selection operation of the moving directions of each mesh in the embodiment of FIG. 1.

### DESCRIPTION OF THE PREFERRED EMBODIMENTS

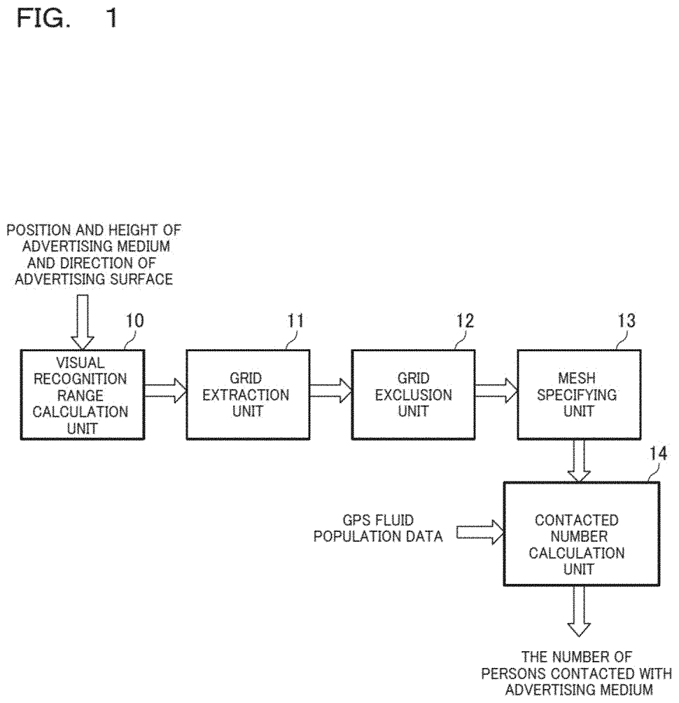

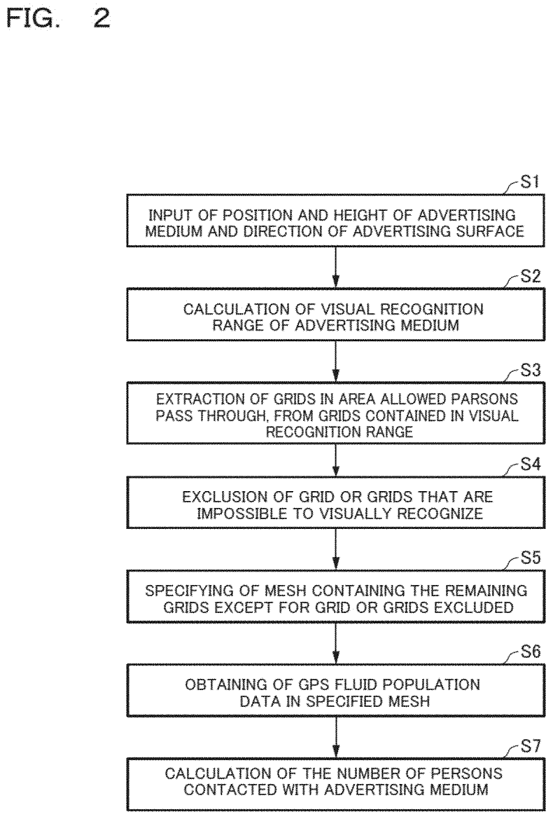

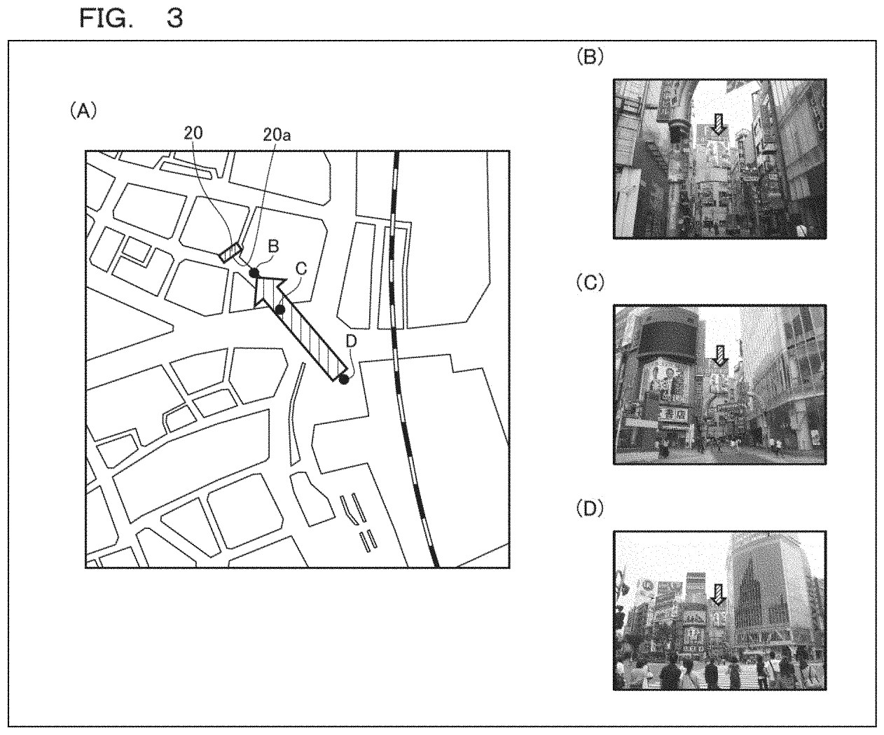

FIG. 1 schematically illustrates a whole configuration of an apparatus for detecting the number of persons contacted with advertising medium in an embodiment according to the present invention, FIG. 2 schematically illustrates an operation of detecting the number of persons contacted with the advertising medium in the embodiment of FIG. 1, and FIG. 3 illustrates the objected advertising medium and the environment around the medium in the embodiment of FIG. 1.

As shown in FIGS. 1 and 3, the apparatus for detecting the number of persons contacted with an advertising medium in this embodiment is basically configured by a program controlled computer, and has a visual-recognition range calculation unit 10 (corresponding to the visual-recognition range calculation means according to the present invention). This visual-recognition range calculation unit 10 calculates a visual recognition ground range of an advertising medium 20 on a map, based on input position data of the advertising medium 20, input height data above the ground of the advertising medium 20, and input direction data of an advertising surface 20a of the advertising medium 20. The apparatus also has a grid extraction unit 11 (corresponding to the section extraction means according to the present invention) for extracting a plurality of grids in an area allowed persons to pass through, from a plurality of square-shaped grids contained in the visual recognition ground range on the map calculated by the visual-recognition range calculation unit 10, a grid exclusion unit 12 (corresponding to the section exclusion means according to the present invention) for excluding a grid or grids that are impossible to visually recognize the advertising medium 20 from the plurality of grids extracted by the grid extraction unit 11, and a mesh specifying unit 13 (corresponding to the area specifying means according to the present invention) for specifying a mesh that contains the remaining grids except a grid or grids excluded by the grid exclusion unit 12. Furthermore, the apparatus has a contacted number calculation unit 14 (corresponding to the contacted number calculation means according to the present invention) for calculating the number of persons contacted with the advertising medium 20 and for outputting the calculated number of persons in accordance with fluid population data of persons moving toward the advertising medium 20 in the mesh specified by the mesh specifying unit 13. In this embodiment, this contacted number calculation unit 14 obtains, from a GPS data supplier, GPS fluid population data of persons moving toward the advertising medium 20 in specified at least one mesh, and calculates the number of persons contacted with the advertising medium 20.

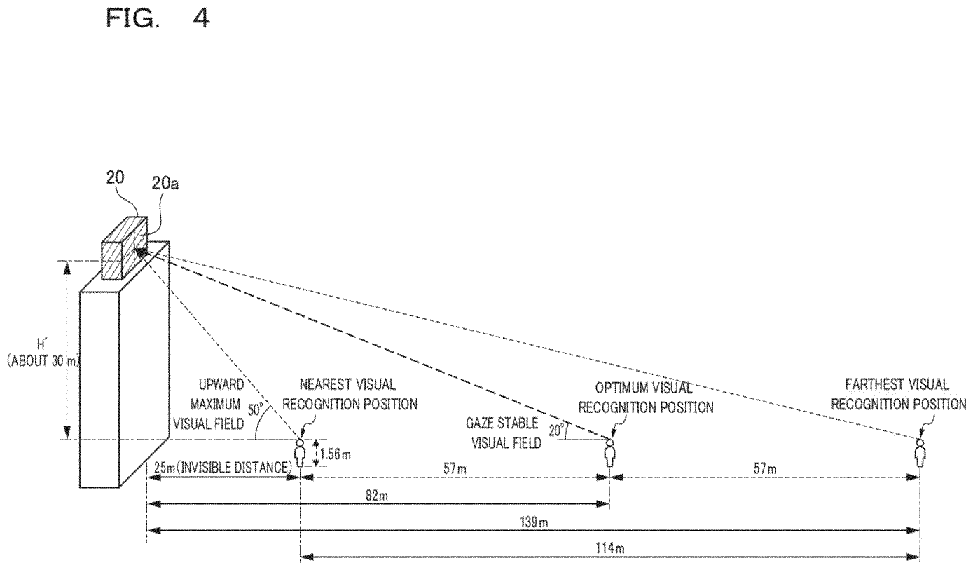

To the visual-recognition range calculation unit 10, as for the information of the objected advertising medium 20, the position data indicating the position of the advertising medium 20, the height data H indicating the height above the ground of the advertising medium 20, and the direction data indicating the facing direction of the advertising surface 20a of the advertising medium 20 are input (Step S1 of FIG. 2). The position data is the coordinate in the map or the latitude and the longitude of the advertising medium 20. The height data H is data indicating a height of the center of the advertising medium 20 from the ground. In this embodiment, since the advertising medium 20 is mounted on the building roof of the seventh floor and the height of the advertising medium 20 itself is 1.4 m, the height H is given as H=4 m×7+1.4 m/2 (the height of each floor assumes 4 m in the commercial building). Namely, the height H is H=28.7 m. If 1.56 m that is the height of a viewpoint of average Japanese is deducted from the height H above the ground, the height H′ from the average Japanese viewpoint to the center of the advertising medium 20 becomes as H′=28.7 m−1.56 m=27.14 m (in the following description, it is assumed for simplicity that H′ is approximately 30 m). If the height data H′ about the advertising medium 20 is derived from geographic data directly, it is possible to use this derived value. The direction data is determined from the facing direction of the advertising surface 20a of the advertising medium 20. In this embodiment, since the advertising surface 20a faces to the southeast, the direction data is an azimuth data or an angle data of 8 directions (cardinal and intermediate directions), corresponding to this southeastern direction. Then, the visual-recognition range calculation unit 10 calculates respectively an optimum visual recognition position (best position), a nearest visual recognition position and a farthest visual recognition position on a line extending, on the ground, along the direction to which the advertising surface 20a of the advertising medium 20 faces as shown in FIG. 4.

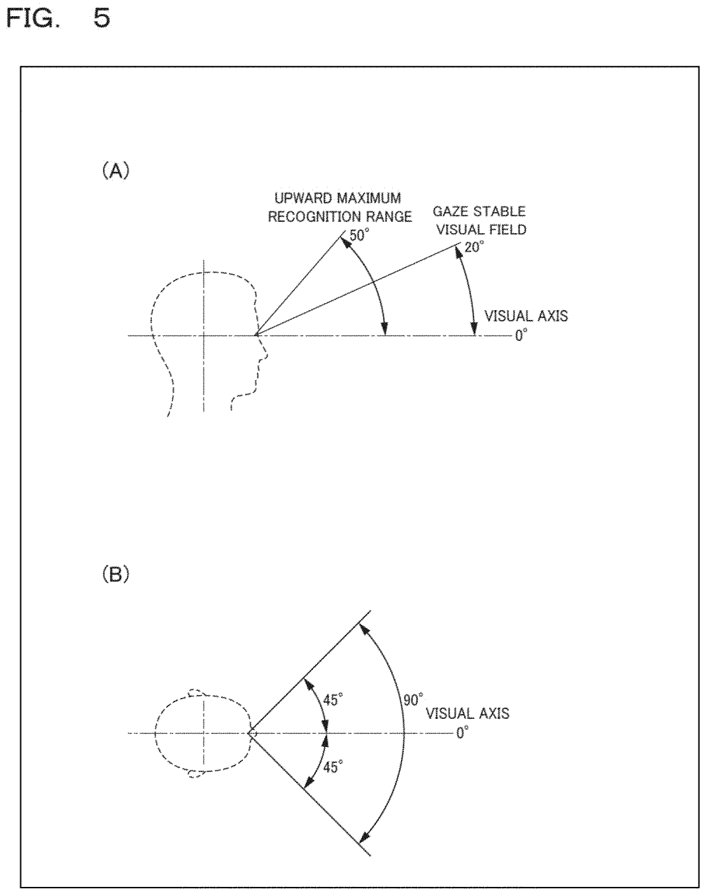

The optimum visual recognition position is, as shown in FIG. 5 (A), a position where the advertising medium 20 can be recognized with an angle range between the horizontal angle (visual axis angle) and the 20 degree upward angle, which range is the gaze stable visual field in upward and downward directions. In this gaze stable visual field, human can comfortably watch the object only with the movement of his head and eyeball. In this embodiment, this optimum visual recognition position is located at a point of 82 m from the advertising medium 20 if the height H′ of the center of the advertising medium 20 from the view point is approximately 30 m, as shown in FIG. 4. The nearest visual recognition position is a position where the advertising medium 20 can be recognized with an angle range between the horizontal angle (visual axis angle) and the 50 degree upward angle that is the upward limit angle for viewing. In this embodiment, this nearest visual recognition position is located at a point of 25 m from the advertising medium 20 if the height H′ of the center of the advertising medium 20 from the viewpoint is approximately 30 m, as shown in FIG. 4. The farthest visual recognition position is the maximum distance position where the advertising medium 20 can be visually recognized. In this embodiment, this farthest visual recognition position is located at a point far from the advertising medium 20 by a distance of the optimum visual recognition posit ion from the advertising medium 20 plus a distance (57 m) between the nearest visual recognition position and the optimum visual recognition position, namely located at a point of 139 m (82 m+57 m) far from the advertising medium 20, as shown in FIG. 4.

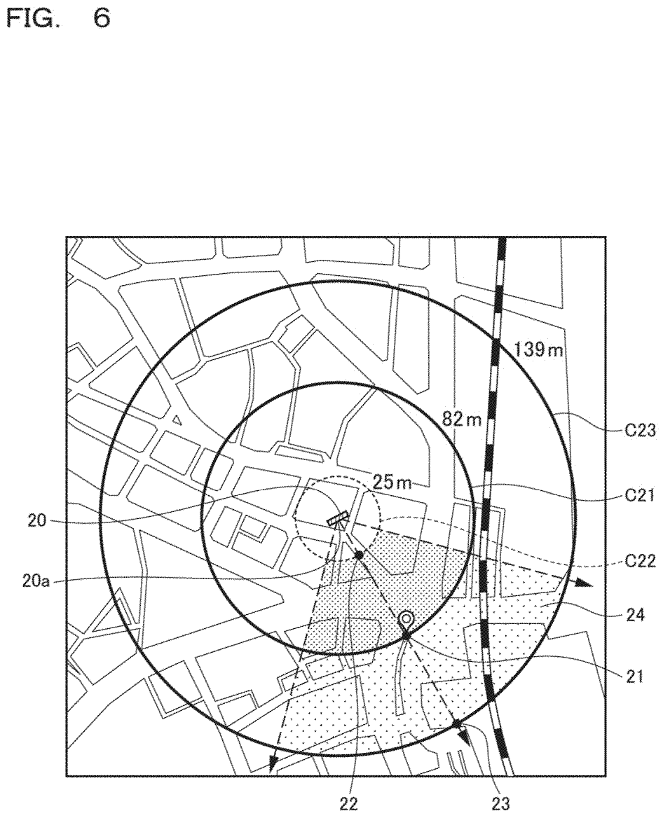

In FIG. 6, on the ground, described are circles C21, C22 and C23 having the common circle center located at the center of the advertising surface 20a of the advertising medium 20 and passed through the optimum visual recognition position 21, the nearest visual recognition position 22 and the farthest visual recognition position 23, respectively. The visual recognition range is defined as an area formed by excluding an area (invisible area) of the circle C22 having a radius of 25 m and passing through the nearest visual recognition position 22, from an area of the circle C23 having a radius of 139 m and passing through the farthest visual recognition position 23. Also, as shown in FIG. 6, the visual recognition range of the advertising medium 20 is defined as an arc area 24 (shaded area) within an angle range between the right and left 45 degrees around the center of the advertising surface 20a of the advertising medium 20 if it is determined that, as shown in FIG. 5 (B), no one can see the advertising medium 20 at a position over the angle range between the right and left 45 degrees (90 degrees in total) from the front of the medium (visual axis), which range is the gaze stable visual field in right and left directions. Namely, the visual-recognition range calculation unit 10 calculates an area sandwiched by the circle C22 and the circle C23 and contained within the angle range of 90 degrees as the visual recognition range 24 of the advertising medium 20 (Step S2 of FIG. 2).

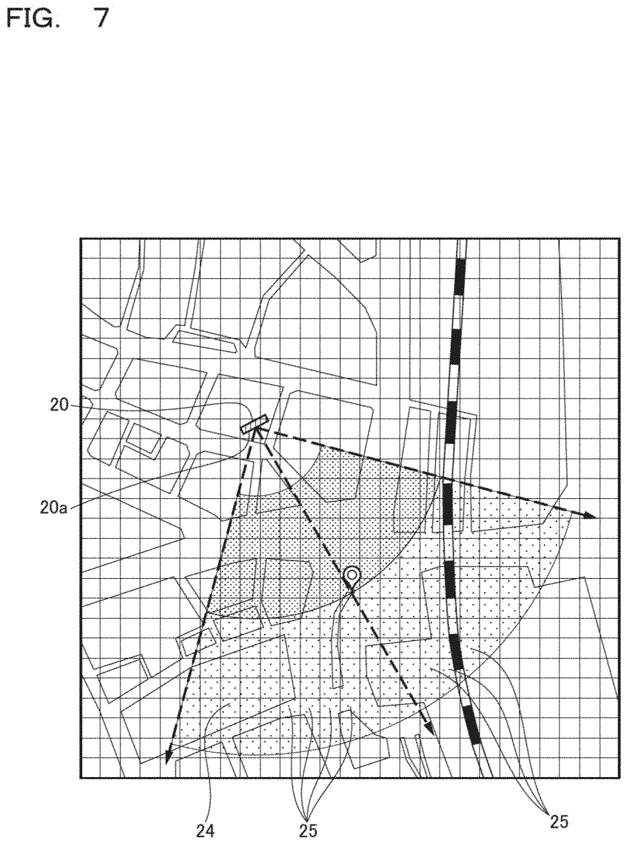

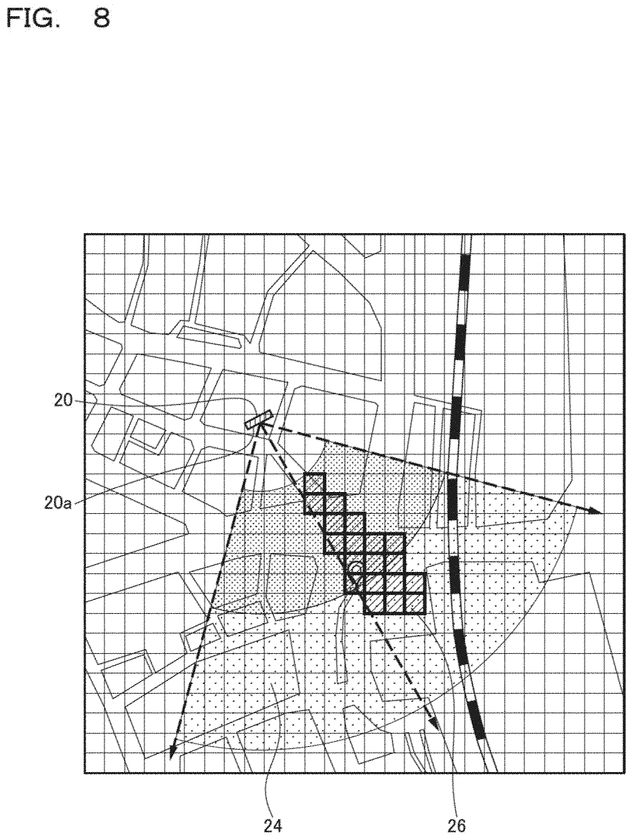

As shown in FIG. 7, the grid extraction unit 11 at first sets, on a map, square-shaped grids 25 (corresponding to the sections according to the present invention) that cover such calculated visual recognition range 24. Each grid 25 is formed in this embodiment in square shape with 1 m×1 m for example but it is not necessary to form in the square shape. For example, the grid may be formed in a rectangular shape or other shape. Also, the dimension of each side of the grid is not limited to 1 m×1 m, but may be appropriately determined depending on the processing capacity of the computer of the system. Then, the grid extraction unit 11 extracts grids 26 existing in the area such as a road area or a passage area for example, allowed persons to pass through, from thus set grids 25 (Step S3 of FIG. 2). More concretely, the grid extraction unit 11 compares the coordinate or the latitude and the longitude of the center of each square-shaped grid 25 with the coordinate or the latitude and the longitude of each road or passage set in a map, and extracts only grids 26 with the center positions that are located within the roads or passages in the map as shown in FIG. 8.

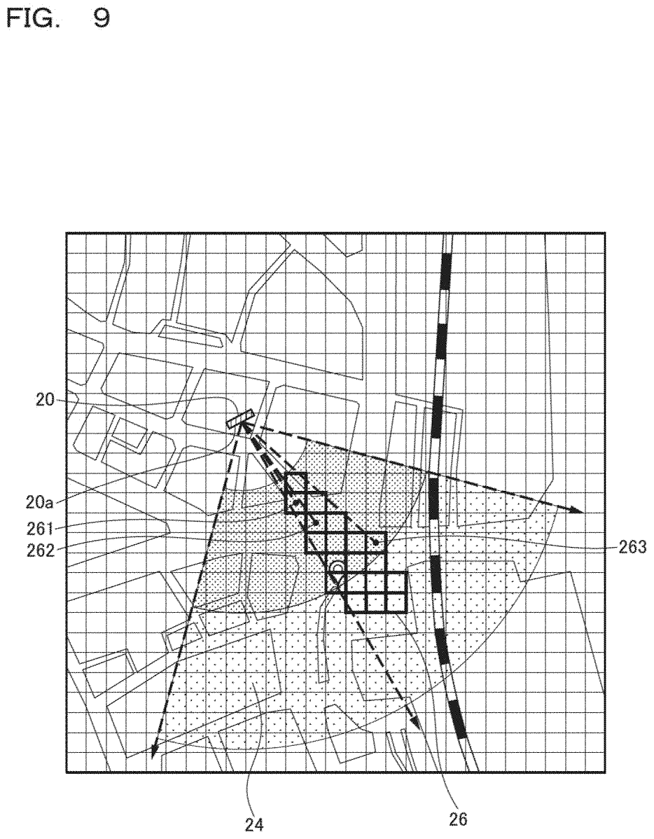

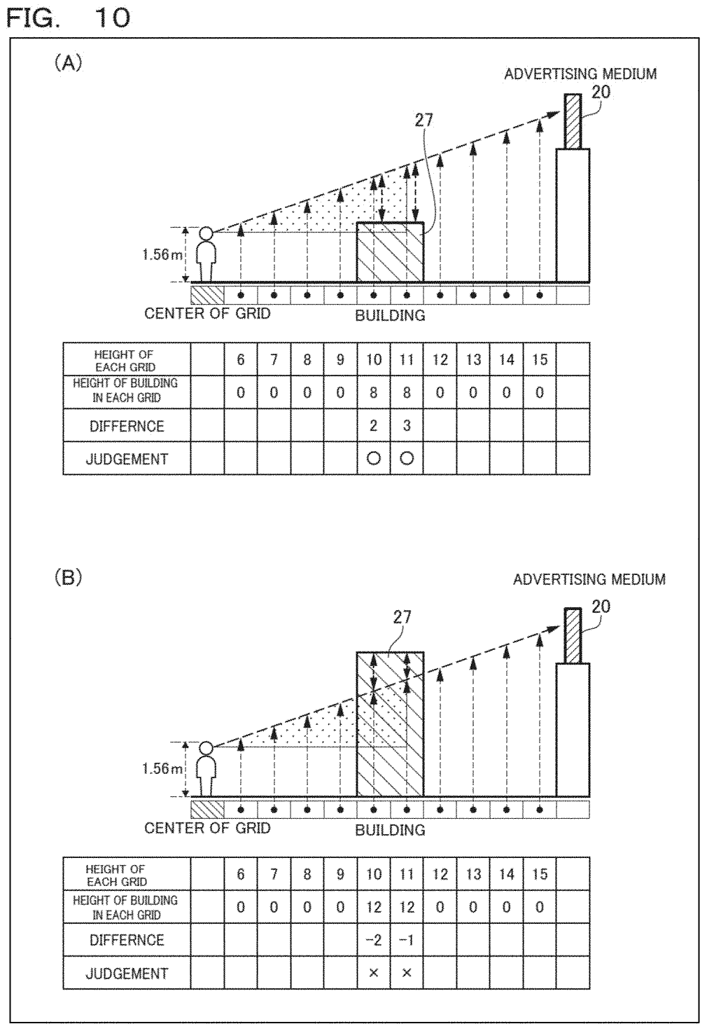

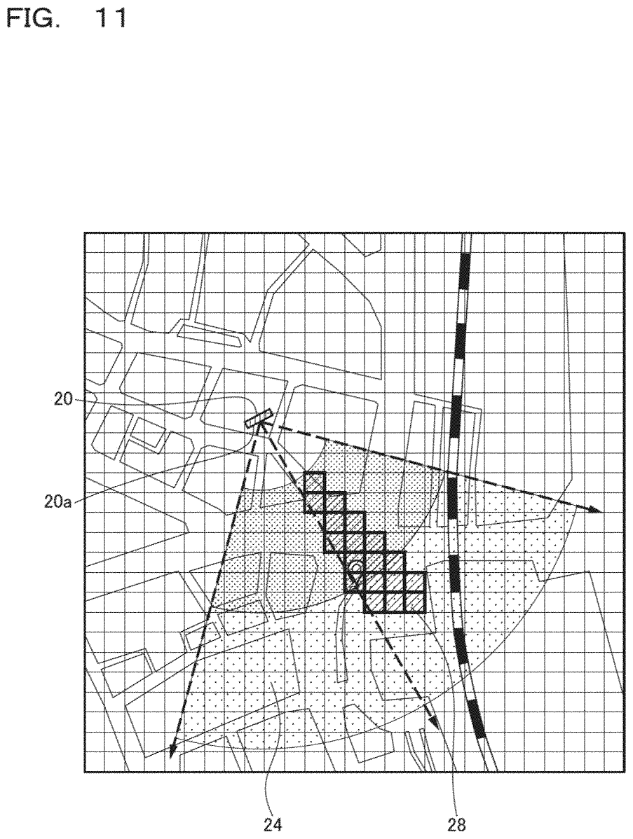

The grid exclusion unit 12 excludes a grid or grids that are impossible to visually recognize the advertising medium 20 from the grids 26 extracted by the grid extraction unit 11 (Step S4 of FIG. 2). Specifically, the grid exclusion unit 12 obtains the height of building or buildings existing in each square-shaped grid 25 from a map data, compares the obtained height of the building with the height of a visual line above the each grid 25, and judges whether the building height is higher than the visual line height above the each grid 25 to intercept the visual line. Each visual line is a line connecting between the center of the advertising surface 20a of the advertising medium 20 and the center of each extracted grid 26 (for example the grid 261, 262 or 263 shown in FIG. 9). As shown in FIG. 10 (A), it is judged that the visual line is not intercepted and that it is possible to visually recognize the advertising medium 20, if the heights, at all passing grids, of the visual line from a certain grid (grid 261 or 262 of FIG. 9 for example) to the advertising medium 20 are higher than the heights of the buildings 27 above which the visual line passes. On the other hand, as shown in FIG. 10 (B), it is judged that the visual line is intercepted and that it is impossible to visually recognize the advertising medium 20, if the heights, at all passing grids, of the visual line from a certain grid (grid 263 of FIG. 9 for example) to the advertising medium 20 are lower than the heights of the buildings 27 above which the visual line passes. Then, the grid exclusion unit 12 excludes the grid (grid 263 of FIG. 9 for example) which is judged as the invisible grid. In FIG. 11, indicated is an area 28 containing only the remaining grids except for the invisible grid (grid 263) excluded, and the grids of the area 28 is given as the final visual recognition range.

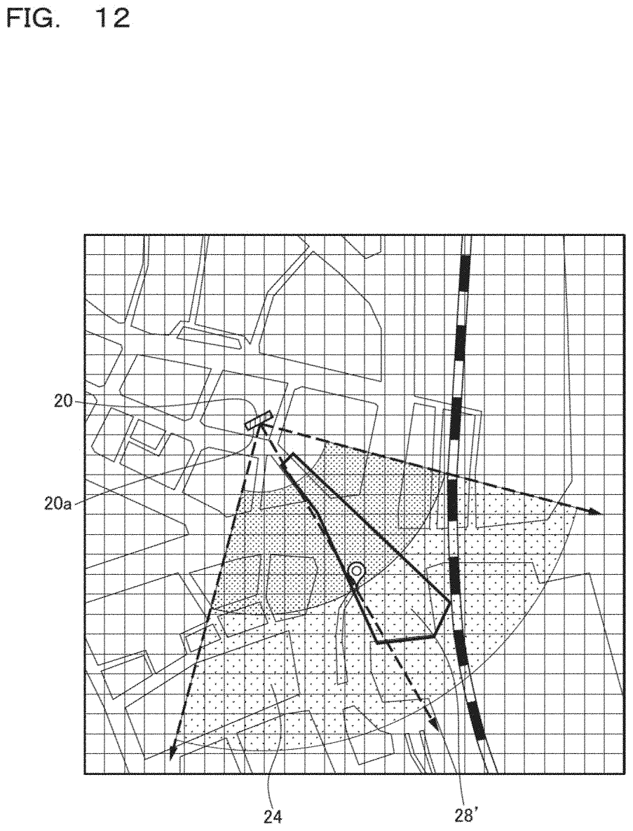

The final visual recognition range is preferably the area 28 with a plurality of grids as shown in FIG. 11. However, in modifications, the final visual recognition range may be an area 28′ with a smooth contour by processing the boundary line in the area of grids smoothly as shown in FIG. 12.

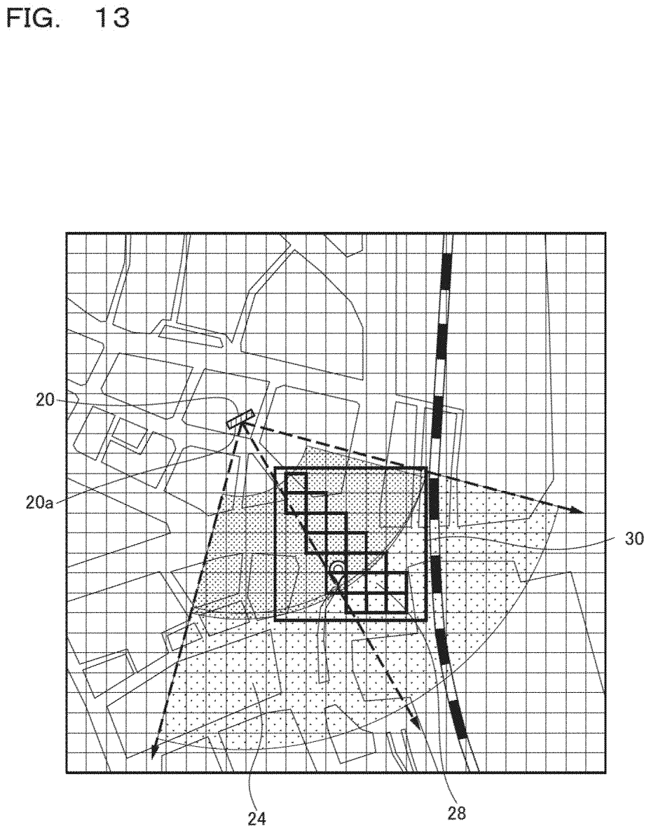

As shown in FIG. 13, the mesh specifying unit 13 specifies a mesh 30 according to regional mesh statistics, which mesh contains an area 28 of the remaining grids except for the grid or grids excluded by the mesh exclusion unit 12 (Step S5 of FIG. 2). More concretely, the mesh specifying unit 13 specifies the mesh 30 containing the centers of the remaining grids among meshes that define GPS fluid population data provided by the GPS data supplier.

The GPS fluid population data commercially available from the GPS data supplier is created by obtaining GPS location information from smartphones of a lot of users, using an installed application of company of the smartphone or its partner company under the condition that the users of the smartphones agree to use of the GPS location information of their smartphones. This mesh type GPS fluid population data is estimated value data obtained by converting the number of the application users into Japanese total population scale to represent its change for each mesh or a plurality of meshes in every month and day and in every period of time. The estimated value of the mesh type GPS fluid population data is provided for each mesh or a plurality of meshes obtained by partitioning a map of all over Japan in each size. As for the mesh size, 1 km×1 km, 500 m×500 m, 100 m×100 m, or 50 m×50 m can be selected in the GPS fluid population data provided by Agoop Co., Ltd. for example. It should be noted that, as for the GPS data supplier, there are several companies other than Agoop Co., Ltd., and GPS fluid population data of any of the GPS data suppliers can be used in the present invention. However, depending on the GPS data supplier, the data formats are somewhat different from each other. Also, it is possible to purchase GPS fluid population data of the area 28′ with the smooth contour shown in FIG. 12 from the GPS data supplier.

Following Table 1 and Table 2 show a part of GPS fluid population data of every hour about the mesh size of 100 m×100 m, provided by Agoop Co., Ltd. Table 1 indicates Month (12 months indication), Day of Week (indication of 0: weekday, indication of 1: holiday, indication of 2: all day), Time (24 hours indication), and estimated values of cumulative total Population (cumulative total number of persons or people) in the specified mesh (represented by Mesh Code and Mesh Name). Table 2 indicates Day of Week (indication of 0: weekday, indication of 1: holiday, indication of 2: all day), Time (24 hours indication), Moving Speed S (8 levels indication of 0-100 km/h), Moving Direction C (8 directions indication of every 45 degrees), and estimated values of Population Ratio (%) in the specified mesh (represented by Mesh Code and Mesh Name). In Table 2, with respect to the Moving Speed S, “1” indicates S=0 km/h, “2” indicates 0 km/h<S≤10 km/h, “3” indicates 10 km/h<S≤20 km/h, “4” indicates 20 km/h<S≤40 km/h, “5” indicates 40 km/h<S≤60 km/h, “6” indicates 60 km/h<S≤80 km/h, “7” indicates 80 km/h<S≤100 km/h, and “8” indicates 100 km/h<S. Also, in Table 2, with respect to the Moving Direction C, “1” indicates 0 degree<C<22.5 degrees or 337.5 degrees≤C (North direction), “2” indicates 22.5 degrees≤C<67.5 degrees (Northeast direction), “3” indicates 67.5 degrees≤C<112.5 degrees (East direction), “4” indicates 112.5 degrees≤C<157.5 degrees (Southeast direction), “5” indicates 157.5 degrees≤C<202.5 degrees (South direction), “6” indicates 202.5 degrees≤C<247.5 degrees (Southwest direction), “7” indicates 247.5 degrees≤C<292.5 degrees (West direction), and “8” indicates 292.5 degrees≤C<337.5 degrees (Northwest direction).

TABLE 1

| | | | Day of | | |
|---|---|---|---|---|---|
| Mesh Code | Mesh Name | Month | Week | Time | Population |
| 5 | Center Street 1 | 1 | 0 | 0 | 8829.49482 |
| 5 | Center Street 1 | 1 | 0 | 1 | 2505.56557 |
| 5 | Center Street 1 | 1 | 0 | 2 | 1660.64148 |
| 5 | Center Street 1 | 1 | 0 | 3 | 1496.63546 |
| 5 | Center Street 1 | 1 | 0 | 4 | 1768.61685 |
| 5 | Center Street 1 | 1 | 0 | 5 | 3272.21983 |
| 5 | Center Street 1 | 1 | 0 | 6 | 3397.85832 |
| 5 | Center Street 1 | 1 | 0 | 7 | 5380.61457 |
| 5 | Center Street 1 | 1 | 0 | 8 | 8429.37179 |
| 5 | Center Street 1 | 1 | 0 | 9 | 11760.7634 |
| 5 | Center Street 1 | 1 | 0 | 10 | 14251.8695 |
| 5 | Center Street 1 | 1 | 0 | 11 | 17862.8774 |
| 5 | Center Street 1 | 1 | 0 | 12 | 21044.1268 |
| 5 | Center Street 1 | 1 | 0 | 13 | 22933.6968 |
| 5 | Center Street 1 | 1 | 0 | 14 | 23243.0556 |
| 5 | Center Street 1 | 1 | 0 | 15 | 25738.6502 |
| 5 | Center Street 1 | 1 | 0 | 16 | 27950.0819 |
| 5 | Center Street 1 | 1 | 0 | 17 | 28284.8867 |
| 5 | Center Street 1 | 1 | 0 | 18 | 24414.2686 |
| 5 | Center Street 1 | 1 | 0 | 19 | 19810.7758 |
| 5 | Center Street 1 | 1 | 0 | 20 | 17362.7431 |
| 5 | Center Street 1 | 1 | 0 | 21 | 15676.8493 |
| 5 | Center Street 1 | 1 | 0 | 22 | 14210.5346 |
| 5 | Center Street 1 | 1 | 0 | 23 | 1660.64148 |
| 5 | Center Street 1 | 1 | 1 | 0 | 1496.63546 |
| 5 | Center Street 1 | 1 | 1 | 1 | 1768.61685 |
| 5 | Center Street 1 | 1 | 1 | 2 | 3272.21983 |
| 5 | Center Street 1 | 1 | 1 | 3 | 3397.85832 |

TABLE 2

| | | Day | | | | Pop- |
|---|---|---|---|---|---|---|
| Mesh | | of | | Moving | Moving | ulation |
| Code | Mesh Name | Week | Time | Speed | Direction | Ratio |
| 5 | Center Street 1 | 0 | 0 | 1 | 1 | 4% |
| 5 | Center Street 1 | 0 | 0 | 1 | 2 | 3% |
| 5 | Center Street 1 | 0 | 0 | 1 | 3 | 3% |
| 5 | Center Street 1 | 0 | 0 | 1 | 4 | 2% |
| 5 | Center Street 1 | 0 | 0 | 1 | 5 | 3% |
| 5 | Center Street 1 | 0 | 0 | 1 | 6 | 4% |
| 5 | Center Street 1 | 0 | 0 | 1 | 7 | 3% |
| 5 | Center Street 1 | 0 | 0 | 1 | 8 | 2% |
| 5 | Center Street 1 | 0 | 0 | 2 | 1 | 12% |
| 5 | Center Street 1 | 0 | 0 | 2 | 2 | 6% |
| 5 | Center Street 1 | 0 | 0 | 2 | 3 | 8% |
| 5 | Center Street 1 | 0 | 0 | 2 | 4 | 6% |
| 5 | Center Street 1 | 0 | 0 | 2 | 5 | 8% |
| 5 | Center Street 1 | 0 | 0 | 2 | 6 | 8% |
| 5 | Center Street 1 | 0 | 0 | 2 | 7 | 10% |
| 5 | Center Street 1 | 0 | 0 | 2 | 8 | 10% |

The contacted number calculation unit 14 obtains, from the GPS data supplier (Agoop Co., Ltd.), GPS fluid population data by specifying the moving speed and the moving direction of pedestrians in the mesh 30 specified by the mesh specifying unit (Step S6 of FIG. 2).

As for the moving speed of pedestrians in this embodiment, since a human average walking speed is 4.8 km/h, the moving speed of 0 km/h<S≤10 km/h (data indicating “2” in Table 2) is selected and acquired from the GPS fluid population data. By selecting the moving speed of 0 km/h<S≤10 km/h, it is possible to exclude persons moving by a train, an automobile, a motorcycle and a bicycle.

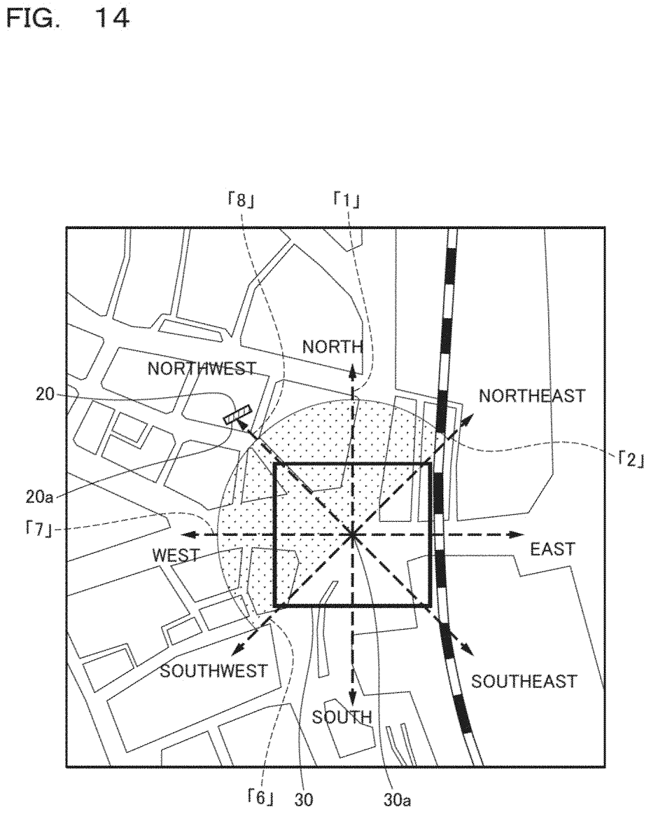

As for the moving direction of pedestrians in this embodiment, GPS fluid population data with respect to 5 directions defined by the direction to which the advertising surface 20a of the advertising medium 20 faces are selected and acquired from the predetermined 8 directions (North, Northeast, East, Southeast, South, Southwest, West, and Northwest). That is, as shown in FIG. 14, since the direction to which the advertising surface 20a of the advertising medium 20 faces is Southeast, the GPS fluid population data of the mesh 30 in the 5 directions constituted by the direction Northwest that is opposed to Southeast and the neighboring 4 directions North, West, Northeast and Southwest are selected and acquired. More concretely, the GPS fluid population data in the 5 directions consisting of the direction “1” of 0 degree<C<22.5 degrees or 337.5 degrees≤C (North direction), the direction of “2” of 22.5 degrees≤C<67.5 degrees (Northeast direction), the direction “6” of 202.5 degrees≤C<247.5 degrees (Southwest direction), the direction “7” of 247.5 degrees≤C<292.5 degrees (West direction), and the direction “8” of 292.5 degrees≤C<337.5 degrees (Northwest direction) are selected and acquired. Note that if the facing direction of the advertising surface 20a does not fit either of the 8 directions perfectly, the nearest direction of one of the 8 directions may be selected and acquired. Although the predetermined directions are 8 directions in the aforementioned embodiment, they may be 16 directions in modifications.

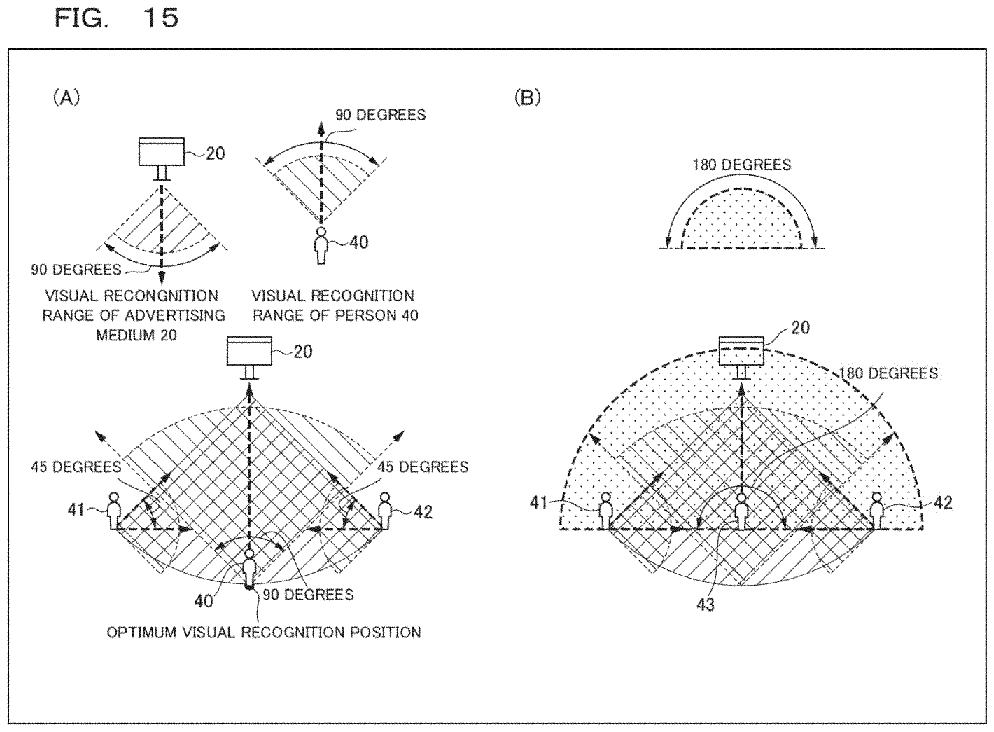

As shown in FIG. 15 (A), the visual recognition range of the advertising medium 20 is an angle range of 90 degrees with respect to the direction to which the advertising surface 20a faces, and the visual recognition range of the person 40 at the optimum visual recognition position is an angle range of 90 degrees with respect to the direction toward the advertising surface 20a. Since angle ranges of persons 41 and 42 positioned at the both ends of the visual recognition range of the advertising medium 20 capable of visually recognizing the advertising medium 20 are 45 degrees, respectively, the maximum visual recognition angle of a person 43 in the visual recognition range of the advertising medium 20 becomes 180 degrees corresponding to the aforementioned 5 directions.

Note that although the number of pedestrians or walking persons contacted with the advertising medium is detected in the aforementioned explanation, the number of persons on vehicles such as bicycles, motorcycles, automobiles or trains, contacted with the advertising medium can be similarly detected. For example, in case of the bicycles, since their average moving speed is 14-15 km/h, the GPS fluid population data with the moving speed of 10 km/h<S≤20 km/h will be acquired. In case of the motorcycles, the automobiles or the trains, the GPS fluid population data with the moving speed of 20 km/h<S≤40 km/h or 40 km/h<S≤60 km/h will be acquired. By utilizing this process, it may be possible to detect the number of persons contacted with such as guide signboards located at the road side.

In detail, the contacted number calculation unit 14 at first obtains the estimated value of cumulative total population (cumulative total number of persons or people) in the specified mesh 30 at the specified day of week and time among the GPS fluid population data provided by the GPS data supplier. If the mesh cord of the mesh 30 is “5” with the mesh name of “Center Street 1”, the estimated value of cumulative total population at the time of “0:00” in “weekday” of January is “8829.49482” from the data in the gray part with shade in Table 1. Note that this cumulative total number of persons is a cumulative total number of persons or people an hour, calculated by excluding the number of persons or people stayed in the same mesh over one hour. The fluid population calculation unit 14 also obtains the estimated value of population ratio (%) with the moving speed S of 0 km/h<s≤10 km/h indicated “2”, and with the moving direction C in the mesh 30 of 0 degree≤C<22.5 degrees or 337.5 degrees≤C indicated “1”, of 22.5 degrees≤C<67.5 degrees indicated “2”, of 202.5 degrees≤C<247.5 degrees indicated “6”, of 247.5 degrees≤C<292.5 degrees indicated “7”, and of 292.5 degrees≤C<337.5 degrees indicated “8”, among the GPS fluid population data provided from the GPS data supplier. These estimated values of the population ratio in the 5 directions are “12%”, “6%”, “8%”, “10%” and “10%” from the data in the gray part with shade in Table 2.

Then, the contacted number calculation unit 14 calculates estimated values of cumulative total population moving towards the 5 directions at the walking speed based on the obtained estimated value of cumulative total population and on the obtained estimated values of population ratio moving towards the each direction at the walking speed. Thereafter, the contacted number calculation unit 14 calculates the number of pedestrians or walking persons contacted with the advertising medium by adding these calculated estimated values of cumulative total population moving towards the 5 directions at the walking speed with each other (Step S7 of FIG. 2). More concretely, the estimated value of persons contacted with the advertising medium is calculated as follows in this example. 8829.49482 (persons)×12(%)+8829.49482 (persons)×6(%)+8829.49482 (persons)×8(%)+8829.49482 (persons)×10(%)+8829.49482 (persons)×10(%)=4061.56761 (persons). Namely, the medium contacted number in the mesh 30 is “4061 (persons)”, and this number of persons becomes the number of persons contacted with the advertising medium 20 finally.

If a plurality of meshes containing the final visual recognition range 28 are specified by the mesh specifying unit 13, the contacted number calculation unit 14 specifies, in an area integrating all the plurality of meshes, the moving speed of pedestrians or persons or vehicle and the directions, and obtains the GPS fluid population data prepared by the GPS data supplier. The GPS data supplier is able to supply GPS fluid population data of the designated moving speed and direction not only in an area of a single mesh but also in an area integrating a plurality of meshes or in an area with an optional shape.

There are two kinds of GPS fluid population data for each mesh provided by the GPS data supplier, namely “average population data” and “cumulative total population data” of mesh. The “average population data” is data representing the number of people or persons in a mesh, converted into the total population of Japan. According to this “average population data”, for example, it is counted as “1” if a person stays in a mesh for one hour, and it is counted as “⅙” if a person stays for ten minutes. On the other hand, the “cumulative total population data” is data representing simply the number of people or persons in a mesh at that time without considering staying period of time in the mesh (however, in case that the staying time is greater than one hour is excluded). Thus, according to this “cumulative total population data”, it is counted as “1”, when a person passes a mesh even if the staying period of time in the mesh is 5 minutes or 10 minutes. It should be noted that since the number of the advertising medium contacted persons is to be detected according to the present invention, a person merely passing through the mesh should be counted as the visually recognized number. Thus, it is important to use the “cumulative total population data” as the fluid population data.

As discussed in detail above, in this embodiment, the visual-recognition range calculation unit 10 provides, from the position data the height data H of the advertising medium 20, the circles C21, C22 and C23 having the common circle center located at the center of the advertising surface 20a of the advertising medium 20 and passed through the optimum visual recognition position 21, the nearest visual recognition position 22 and the farthest visual recognition position 23, respectively. The visual recognition range is defined as an area formed by excluding an area of the circle C22 passing through the nearest visual recognition position 22, from an area of the circle C23 passing through the farthest visual recognition position 23. Also, the arc area 24 within an angle range between the right and left 45 degrees around the center of the advertising surface 20a is provided from the direction of the advertising surface 20s. That is, the area sandwiched by the circle C22 and the circle C23 and contained within the angle range of 90 degrees is defined as the visual recognition range 24 of the advertising medium 20. The grid extraction unit 11 sets a plurality of square-shaped grids 25 that cover all of such defined visual recognition range 24. Each grid 25 is for example a square of 1 m×1 m. Furthermore the grid extraction unit 11 extracts grids 26 existing in the area such as a road area or a passage area for example, allowed persons to pass through, from thus set grids 25. Then, the grid exclusion unit 12 excludes a grid or grids that are impossible to visually recognize the advertising medium 20 due to buildings for example from the grids 26 extracted by the grid extraction unit 11. The area 28 with the remaining grids except for the excluded grid or grids that are impossible to visually recognize the advertising medium 20 becomes the final visual recognition range. Then, the mesh specifying unit 13 specifies a mesh 30 according to regional mesh statistics, which mesh 30 contains the area 28 of the final visual recognition range. The contacted number calculation unit 14 calculates the number of persons contacted with the advertising medium 20 in the specified mesh 30. That is, the number of persons or people contacted with the advertising medium 20 is calculated by obtaining estimated values of fluid population with the designated moving speed and the designated moving directions among GPS fluid population data for each mesh, provided by GPS data suppliers such as Agoop Co., Ltd. for example. According to this embodiment, the meshes that can visually recognize the advertising medium 20 are specified and the number of persons or people contacted with the advertising medium 20 is obtained from the fluid population data moving toward the advertising medium 20 within the specified meshes. Thus, the number of the medium contacted persons in an arbitrary time period can be always precisely and easily detected without really performing any people number investigation, even about the OOH mediums that are difficult for detecting the number of the medium contacted persons.

In the aforementioned embodiment, the mesh type fluid population data provided by the data supplier as the fluid population data is used. However, the present invention can be realized without using such fluid population data defined by mesh. For example, fluid population data using the concept of Geofence or Geofencing representing an area surrounded by a virtual boundary line may be used. In this case, an area with an arbitrary shape is set as Geofence, and in this set area, fluid population data moving toward the advertising medium may be acquired or calculated.

Also, in the aforementioned embodiment, moving speed of target is used for knowing whether the target is a pedestrian or a person riding on vehicle. However, according to the present invention, it is possible to know by other method whether it is a pedestrian or a person riding on vehicle. For example, it is possible to know whether the target moves along a road, a sidewalk or a train track by overlapping the moving trace of the target onto the map. Furthermore, it is possible to obtain fluid population data from the data supplier by measuring the moving speed based on the time and the distance between the data acquisition points and by specifying the moving target from the measured moving speed and the moving paths. Such fluid population data may be obtained for example as KDDI Location Analizer or KDDI Location Data.

Although in the aforementioned embodiment the GPS fluid population data commercially-available from an authorized data supplier is used, similar fluid population data may be obtained from various kinds of data suppliers. However, the method of collecting such available fluid population data and the data format of the fluid population data are somewhat different depending on the data suppliers. In order to acquire location information, GPS or location information of the base station may be used.

Many widely different embodiments of the present invention may be constructed without departing from the spirit and scope of the present invention. It should be understood that the present invention is not limited to the specific embodiments described in the specification, except as defined in the appended claims.

### DENOTATION OF REFERENCE NUMERALS

10: visual recognition range calculation unit
11: grid extraction unit
12: grid exclusion unit
13: mesh specifying unit
14: contacted number calculation unit
20: advertising medium
20a: advertising surface
21: optimum visual recognition position
22: nearest visual recognition position
23: farthest visual recognition position
24: visual recognition range
25, 261, 262, 263: grid
26: grid existing within passable area
27: buildings
28: area containing the remaining meshes
28′: area with smooth contour
30: mesh
30a: center of mesh
40, 41, 42, 43: person

1. An apparatus for detecting the number of persons contacted with an advertising medium, comprising:
a visual-recognition range calculation means for calculating a visual recognition ground range of said advertising medium based on a position of said advertising medium, a height above the ground of said advertising medium and a direction of an advertising surface of said advertising medium;
a section extraction means for extracting a plurality of sections in an area allowed persons to pass through, from a plurality of sections contained in the visual recognition ground range calculated by said visual-recognition range calculation means;
a section exclusion means for excluding at least one section that is impossible to visually recognize said advertising medium from the plurality of sections extracted by said section extraction means;
an area specifying means for specifying an area that contains the remaining sections except the at least one section excluded by said section exclusion means; and
a contacted number calculation means for calculating the number of persons contacted with said advertising medium by obtaining fluid population data of persons moving toward said advertising medium in the area specified by said area specifying means.

2. The apparatus for detecting the number of persons contacted with an advertising medium as claimed in claim 1, wherein said area specifying means comprises a mesh specifying means for specifying at least one mesh that contains the remaining sections except for the at least one section excluded by said section exclusion means.

3. The apparatus for detecting the number of persons contacted with an advertising medium as claimed in claim 1, wherein said contacted number calculation means comprises means for obtaining fluid population data of pedestrians or persons on vehicles who are able to visually confirm said advertising medium.

4. The apparatus for detecting the number of persons contacted with an advertising medium as claimed in claim 3, wherein said contacted number calculation means comprises means for obtaining fluid population data of persons moving toward said advertising medium with a speed within a speed range corresponding a moving speed of pedestrians or a moving speed of vehicles.

5. The apparatus for detecting the number of persons contacted with an advertising medium as claimed in claim 1, wherein said contacted number calculation means comprises means for obtaining fluid population data of persons moving toward a plurality of orientations that are defined based on a direction of said advertising surface of said advertising medium.

6. The apparatus for detecting the number of persons contacted with an advertising medium as claimed in claim 2, wherein said mesh specifying means comprises means for specifying at least one mesh that contains a center of the remaining section except for the at least one section excluded by said section exclusion means.

7. The apparatus for detecting the number of persons contacted with an advertising medium as claimed in claim 1, wherein said visual-recognition range calculation means comprises means for calculating an arc range between a first arc having an arc center which is the center of said advertising surface and passing through a nearest visual recognition position, and a second arc having an arc center which is the center of said advertising surface and passing through a farthest visual recognition position, in case that an optimum visual recognition position is defined as a point of intersection with a first downward line and the ground, said first downward line being inclined by a first predetermined angle decided based on gaze stable visual field of humans from a perpendicular line of said advertising surface of said advertising medium, said perpendicular line passing through the center of said advertising surface, that said nearest visual recognition position is defined as a point of intersection with a second downward line and the ground, said second downward line being inclined by a second predetermined angle decided based on upward maximum visual field of humans from the perpendicular line of said advertising surface, and that said farthest visual recognition position is defined as a point away from said optimum visual recognition position on the ground by a distance between said optimum visual recognition position and said nearest visual recognition position in a direction opposite to the center of said advertising surface.

8. The apparatus for detecting the number of persons contacted with an advertising medium as claimed in claim 7, wherein said visual-recognition range calculation means comprises means for calculating the arc range within an angle range of 45 degrees in the right and left of the center of said advertising surface.

9. The apparatus for detecting the number of persons contacted with an advertising medium as claimed in claim 7, wherein said first predetermined angle is 20 degrees and said second predetermined angle is 50 degrees.

10. The apparatus for detecting the number of persons contacted with an advertising medium as claimed in claim 1, wherein said section extraction means comprises means for extracting, in reference to a map data, sections in an area corresponding to roads within the plurality of sections contained in the visual recognition ground range.

11. The apparatus for detecting the number of persons contacted with an advertising medium as claimed in claim 1, wherein said section exclusion means comprises means for comparing a building height calculated with reference to a map data in each section through which at least one line connecting between the center of the extracted section and the center of the advertising surface passes, with a height of the at least one connecting line, and means for excluding the compared section from the plurality of sections extracted by said section extraction means when the building height is higher than the height of the at least one connecting line.

12. The apparatus for detecting the number of persons contacted with an advertising medium as claimed in claim 2, wherein each of the sections extracted is a square-shaped grid.

13. A method of detecting the number of persons contacted with an advertising medium, comprising the steps of:
calculating a visual recognition ground range of said advertising medium based on a position of said advertising medium, a height above the ground of said advertising medium and a direction of an advertising surface of said advertising medium;
extracting a plurality of sections in an area allowed persons to pass through, from a plurality of sections contained in the visual recognition ground range calculated;
specifying an area that contains the remaining sections except at least one section that is impossible to visually recognize said advertising medium and excluded from the plurality of sections extracted; and
calculating the number of persons contacted with said advertising medium by obtaining fluid population data of persons moving toward said advertising medium in the area specified by said area specifying means.

14. The method of detecting the number of persons contacted with an advertising medium as claimed in claim 13, wherein said step of specifying an area comprises a step of specifying at least one mesh that contains the remaining sections except for the at least one section that is impossible to visually recognize said advertising medium and excluded from the plurality of sections extracted.

15. The method of detecting the number of persons contacted with an advertising medium as claimed in claim 13, wherein said step of calculating contacted number comprises a step of obtaining fluid population data of pedestrians or persons on vehicles who are able to visually confirm said advertising medium.

16. The method of detecting the number of persons contacted with an advertising medium as claimed in claim 15, wherein said step of calculating contacted number comprises a step of obtaining fluid population data of persons moving toward said advertising medium with a speed within a speed range corresponding a moving speed of pedestrians or a moving speed of vehicles.

17. The method of detecting the number of persons contacted with an advertising medium as claimed in claim 13, wherein said step of calculating contacted number comprises a step of obtaining fluid population data of persons moving toward a plurality of orientations that are defined based on a direction of said advertising surface of said advertising medium.
